(19) United States
(12) Patent Application Publication
(10) Pub. No.: US 2010/0050825 A1
(43) Pub. Date: Mar. 4, 2010

(54) Hand tool embodying extensible handle

(76) Inventor: Brett Kelly May, Lake Bay, WA (US)

Correspondence Address: Brett May, 18221 30th St. KPN, Lake Bay, WA, 98349, US

(21) Appl. No.: 12/150,574

(22) Filed: Apr. 28, 2008

Related U.S. Application Data
(60) Provisional application No. 60/915,064, filed on Apr. 30, 2007.

(51) Int. Cl. B25G 1/04; B25B 23/16

(52) U.S. Cl. 81/177.2

(57) ABSTRACT

This invention involves a hand tool having an internal cylinder or cavity into which a handle with a boss at one end is inserted, then which is sealed with a retainer, where said retainer may additionally be a hand tool or mount for a hand tool, and such that the handle is extensible yet will not slide out of the hand tool.

### CROSS REFERENCE TO RELATED APPLICATIONS

Application Number: 60/915,064

Relationship of the Applications: This application claims benefits of the filing date of the provisional application number 60/915,064, made on Apr. 30, 2007, which is a provisional application for the same invention made by the same inventor.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This invention pertains to hand tools, more specifically, to extensible handles for hand tools. Prior art includes extensible handles for hand tools; however, many prior inventions involving extensible handles for hand tools involve an outer handle which slides over a shank attached to or which is part of the hand tool. A patent involving a hand tool having a handle which slides into the body of the hand tool, as does the present invention, is U.S. Pat. No. 1,143,350 patented Jun. 15, 1915 by L. D. Benedict. The Benedict patent, limited to pipe wrenches, and unlike the present invention, prevents the handle from sliding out of the body by means of tapering the cylinder or cavity into which the handle with a similar taper slides. U.S. Pat. No. 4,070,932 patented Jan. 31, 1978 by Jeanotte also involves a hand tool having a handle which slides into the body of the hand tool; however, unlike the present invention, Jeanotte prevents the handle from sliding back out of the body of the hand tool by means of a locking mechanism or latch. This invention has no locking mechanism or latch, but rather provides a positive stop for a sliding handle, to which a hand tool can be mounted, attached or designed around.

### BRIEF SUMMARY OF THE INVENTION

It is an object of the present invention to provide for an improved extensible tool handle which can be easily and quickly extended and retracted.

Another object of the present invention is to provide an extensible tool handle which may be readily utilized to apply different degrees of leverage or torque to a hand tool or mount for a hand tool.

Another object of the present invention is to provide an extensible tool handle which may be readily utilized by a human to apply different degrees of leverage or torque to a hand tool or mount for a hand tool, such that the handle can withstand considerable pressure manually applied against it.

Another object of the present invention is to provide an extensible tool handle which may be utilized in conjunction with most or all hand tools and mounts for hand tools, such as, but not limited to, a pipe wrench, an adjustable open end wrench, a shovel, or a breaker bar, as well as systems which include an operable end included in a system, which may be part of another system.

The present invention achieves the foregoing and other objects by providing an extensible tool handle that slides back and forth in a cylinder, or cavity akin to a cylinder, contained within the body of a hand tool. Said body consists of the tool's operable end and a shank (the shank can have any shape; it may even be indistinguishable from the rest of the body) having a cylinder, or cavity akin to a cylinder, within which the handle slides. One end of the handle has a raised shoulder, or boss, of larger dimension than the rest of the handle. One end of the cylinder, or cavity akin to a cylinder, is designed to accept the handle, the opposite end may be sealed or may have a hole in it capable of passing the shank (but not the boss) of the handle.

After the shoulder or boss of the handle is inserted into the cylinder, or cavity akin to a cylinder, within the body, the handle is prevented from exiting the body by affixing a retainer to the body at the end of the cylinder, or cavity akin to a cylinder, where entry of the handle occurred. Should entry of the handle occur at the distal end of the body, the retainer has a hole through it which is smaller than the handle shoulder or boss, yet slightly larger than the handle shank, and the retainer is the positive stop. Should entry of the handle occur at the operable end of the body, the retainer may manifest features such as being a hand tool or a mount for a hand tool.

### BRIEF DESCRIPTION OF THE SEVERAL VIEWS OF THE DRAWING

### (These Drawings Depict Only the Preferred Embodiment of the Invention)

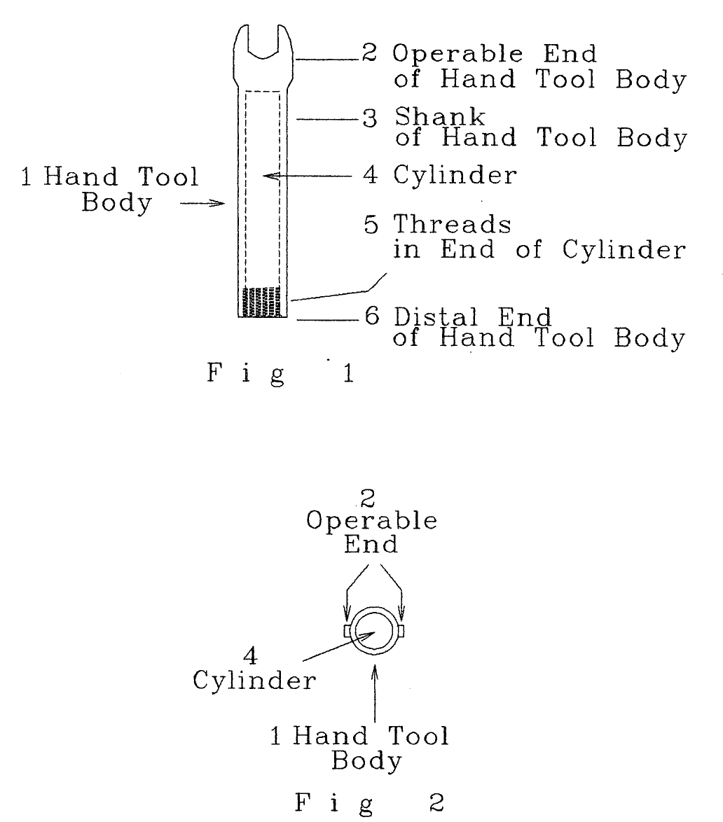

FIG. 1 is a front view of the hand tool body. An open end wrench is chosen, for purposes of simplicity, to represent the operable end.

FIG. 2 is an end view of the hand tool body when viewed from the distal end.

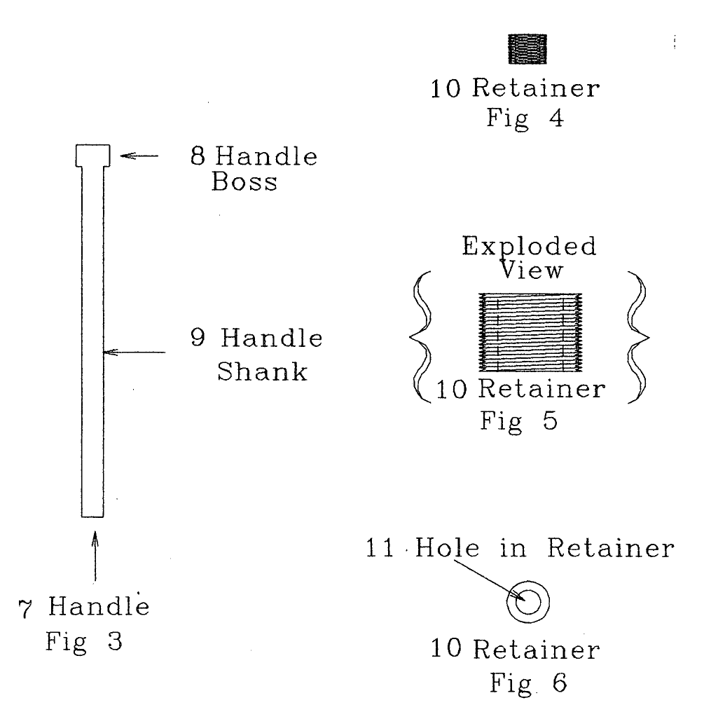

FIG. 3 is a front view of the handle.

FIG. 4 is a front view of the retainer.

FIG. 5 is a larger front view of the retainer.

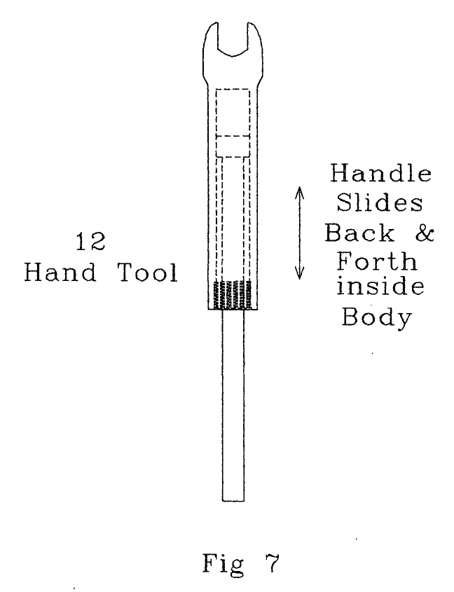

FIG. 6 is an end view of the retainer.

FIG. 7 is a front view of the assembled extendable hand tool.

### DETAILED DESCRIPTION OF THE INVENTION

This detailed description of the invention sets forth but one in depth view of the invention, which description one may think of as a description of the preferred embodiment of the invention; nevertheless, the claims set forth below may include concepts not embodied by these detailed drawings, because, after all, these drawings show only a preferred embodiment of the invention.

This Hand Tool Embodying Extensible Handle is comprised of a hand tool body 1, a handle 7, and a retainer 10. The hand tool body 1 is comprised of an operable end 2, (which, for purposes of simplicity, is shown as an open end wrench, however, the operable end 2 can be any hand tool or mount for which an extendible handle might be advantageous) and a shank 3, which contains a cylinder 4. The cylinder 4 is of uniform dimension, except for the threaded portion 5. The handle 7 is of sufficient length such that it will protrude several inches out of the hand tool body 1 when it is completely inserted into the hand tool body 1, and in addition to it's shank, the handle consists of 1) a shoulder, or boss 8, at one end, which shoulder or boss 8 is of a dimension such that it slides snugly inside the cylinder 4, together with 2) a shank 9, having a lesser dimension, yet which is large enough to grasp and use to control the hand tool 12. The retainer 10, in this preferred embodiment, is a sleeve which will slide snugly over the shank of the handle 9, is threaded on its outside and will screw into the threads in the distal end of the cylinder 5. While the hole in the retainer 11 is slightly larger than the shank of the handle 9, it is smaller than the shoulder, or boss of the handle 8, such that the shoulder, or boss of the handle 8 can not slide through it.

The Hand Tool Embodying Extensible Handle in this preferred embodiment (note this is not always true in all claims set forth below) is assembled by inserting the handle 7, boss 8 first, completely into the cylinder 4 exposed at the distal end 6 of the hand tool body 1. The retainer 10 is then slid over the protruding handle shank 9 and is screwed into the threads in the end of the cylinder 5 within the hand tool body 1.

Thus, a representative and detailed example of Hand Tool Embodying Extensible Handle is set forth immediately above, and other examples of Hand Tool Embodying Extensible Handle exist.

1. Common Elements: I claim the invention of an improvement or improvements to hand tools, or the invention of a new hand tool or tools, where this or these improvement(s) or tool(s) may be said to minimally consist of a body comprised of an operable end and a shank (said operable end having to do with the function of the hand tool and its shank having to do with material which supports the handle), and wherein a handle is inserted into a cylinder or cavity, excluding tapered cylinders, (hereinafter Cylinder) within the body of the hand tool, and said handle slides back and forth within and protrudes out of the body of the hand tool; said invention being also in accord with one or more of the following claims.
I claim the invention comprised of the common elements set forth in 001 above in conjunction with the following: a) the handle, having a shoulder or boss at one end, is inserted boss first into the Cylinder within the hand tool body and thereafter prevented from exiting along the path of entry by a retainer.
I claim the invention comprised of the common elements set forth in 001 above in conjunction with the claim set forth in 002 above and in accord with the following: a) the retainer mentioned in 002 above is slid over the handle then affixed to the hand tool body.
I claim the invention comprised of the common elements set forth in 001 above in conjunction with 002 above and in conjunction with 003 above and the following: a) said retainer, mentioned in 003 above, shall have threads.
I claim the invention comprised of the common elements set forth in 001 above in conjunction with 002 above and in conjunction with 003 above and the following: a) said retainer shall not have threads but rather be affixed to the body by some other means, including, but not limited to: glue, rivets, welding, or force fitting.
I claim the invention comprised of the common elements set forth in 001 above in conjunction with the following: a) the handle is inserted shank first into the body from the operable end, and extended through the distal end, said distal end having an opening slightly larger than the handle shank yet smaller than the handle boss, after which the operable end is modified to prevent the handle from exiting along the path of entry (modifications may include the incorporation of any hand tool or mount or attachment to a hand tool, however assembled or molded or attached).
